(19) United States
(12) Patent Application Publication
(10) Pub. No.: US 2009/0301515 A1
(43) Pub. Date: Dec. 10, 2009

(54) MICROWAVE ASSISTED CHEMICAL STRIPPING OF COATINGS

(75) Inventors: Garimella Balaji Rao, Singapore (SG); Chee Kin Woo, Singapore (SG); Ranjan A/L S. Balakrishnan, Johor Bahru (MY)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORPORATION, Hartford, CT (US)

(21) Appl. No.: 12/485,639

(22) Filed: Jun. 16, 2009

(30) Foreign Application Priority Data
Jun. 6, 2008 (SG) 200804332-5

(51) Int. Cl. B08B 3/04; C23F 1/08

(52) U.S. Cl. 134/1; 156/345.11

(57) ABSTRACT

A method for chemically stripping a metallic coating from a substrate is described. The coating is treated in the presence of microwave energy with a solution containing at least one acid known to dissolve the coating. The application of microwave energy accelerates the dissolution and allows for the use of diluted solutions. Coatings of interest include diffusion aluminides on superalloy substrates.

### CROSS-REFERENCE TO RELATED APPLICATION(S)

Referenced herein is Singapore Patent Application No. 200804332-5 filed Jun. 6, 2008 for “MICROWAVE ASSISTED CHEMICAL STRIPPING OF COATINGS” by Garimella Balaji Rao, Chee Kin Woo, and Ranjan A/L S. Balakrishnan.

### BACKGROUND

The present invention relates to removing a coating from a superalloy substrate. In particular, the invention relates to systems and methods for improving the removal of a coating from a superalloy substrate.

Nickel aluminide and precious metal modified nickel aluminide coatings are employed as environmental barrier coatings and as bondcoats on superalloy turbine components exposed to the extreme operating environments in gas turbine engines.

During operation, the coatings erode and need to be periodically replaced or repaired to extend the life of the gas turbine power plant. Repair is almost always the choice for economic reasons. Because of the corrosion and oxidation products that form on the surfaces, it is necessary to completely remove and reapply the coatings in selected areas before placing the component back in service. Mechanical means of removing the coatings such as abrasive blasting or machining are not preferred because of cost and the chance of harming the underlying substrate.

The method of choice for those experienced in the art is chemical removal (or chemical stripping) wherein the coating to be removed is exposed to a solution that weakens and eventually dissolves the coating. Chemical solutions for removing nickel aluminide coatings are typically aqueous solutions containing at least one of nitric acid, sulfuric acid, or hydrochloric acid and possibly chloride or sulphate ions as taught by U.S. Pat. No. 4,339,282; U.S. Pat. No. 4,425,185; and U.S. Pat. No. 5,944,909 and included herein as reference.

The typical sequence of events in chemically stripping a coating is shown in FIG. 1. A coated substrate is provided in step 10. The substrate is then cleaned, step 20. Chemical means of using detergents, acid, and/or basic washes and mechanical means such as abrasive grit blasting and vapor honing are applied in this step. The chemical stripping solution is then prepared, step 30. Mixtures of nitric acid, hydrochloric acid and water with ferric chloride and copper sulphate additives and mixtures of nitric acid, hydrochloric acid, sulphuric acid and water with ferric chloride and copper sulphate additives are prior art stripping solutions for nickel aluminides. Before applying the stripping solution, the temperature of the solution is adjusted, step 40. Prior art temperatures of up to about 180° F. (82° C.) have been used. The part is exposed to the solution when the solution is ready, step 50. Typically, the part is immersed in the solution for a predetermined time. Depending on the circumstances, times up to about 120 minutes have been required. Prior art has taught that agitating the solution to minimize pitting is beneficial. After a predetermined time, the part is removed from the solution, step 60 and rinsed, step 70. Following rinsing, the degraded coating and reaction products (i.e. smut) are removed by mechanical means such as grit blasting to expose fresh surface, step 80 and the process is repeated until the coating is completely removed, step 90.

Chemical stripping procedures use concentrated acid solutions and are time consuming and expensive. A cost effective method to remove aluminide coatings from superalloy substrates in less time and with dilute solutions would benefit the industry.

### SUMMARY

In one aspect of the invention, the process time for removing aluminide coatings and other bondcoats from superalloy substrates using an aqueous stripping solution containing nitric, sulfuric and/or other acids and chemicals can be significantly shortened by carrying out the process in a microwave environment.

In another aspect of the invention, the process can be carried out using dilute acid solutions.

In another aspect of the invention, the prior art repetitive process of contacting the coating with a stripping solution for a certain period of time followed by abrasive smut removal and repeating the process until the coating is completely removed can be shortened to a single step by carrying out the process in a microwave environment.

### BRIEF DESCRIPTION OF THE DRAWINGS

FIG. 1 lists the steps necessary for prior art chemical stripping of a coating.

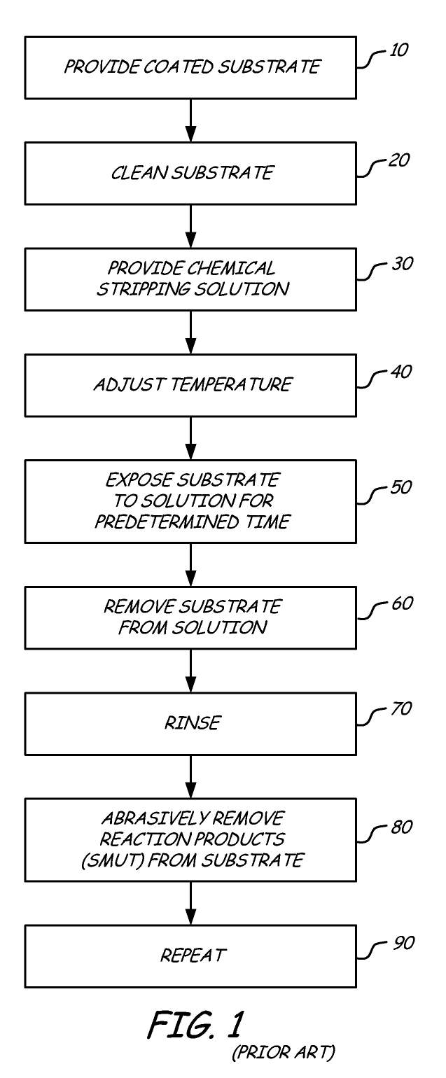

FIG. 2 is a front view showing a turbine blade immersed in an acid solution inside a microwave oven.

### DETAILED DESCRIPTION

The present invention relates to systems and methods for removing a metallic coating from a metallic substrate. In particular, the present invention relates to a method for efficiently removing a diffusion aluminide coating on a superalloy substrate by exposing the coating to a chemical solution containing at least one acid in the presence of microwave energy.

The operating environment of gas turbine components, particularly blades and vanes is both thermally and chemically hostile. As a result, the components are susceptible to oxidation and corrosion attack. To extend component lifetime, the components are protected by an environmental coating alone or in the case where the components are exposed to extreme temperatures, the environmental coating is covered with a ceramic thermal barrier coating (TBC). When a TBC is employed, the environmental coating is called a bondcoat.

Environmental coatings and bondcoats are usually oxidation resistant alloys or intermetallics containing aluminum. Aluminum content enables the slow growth of an adherent and thermally stable protective layer of aluminum oxide (alumina) at elevated temperatures. Popular bondcoats are diffusion aluminides. Diffusion aluminides are typically beta phase nickel aluminide (NiAl) and platinum modified nickel aluminide, NiₓPt_{y}Al, where X+Y=0.5. Diffusion aluminide coatings are formed by diffusion processes such as pack cementation and chemical vapor deposition techniques and are characterized by an outermost additive layer containing an environmentally resistant intermetallic compound MAl where M is iron, nickel, cobalt or platinum or combinations thereof depending on the underlying substrate alloy.

Due to economic factors, it is common practice in the aerospace industry to restore engine run turbine engine components rather than replace them. A typical restoration sequence includes removal of the coating, repair of the underlying superalloy substrate, reapplication of the bondcoat and, if needed, the TBC. Current state of the art techniques for removing the TBC coating include mechanical methods such as grit blasting, vapor honing, and glass bead peening and chemical methods such as molten metal hydroxide and halide gas exposure.

Bondcoat removal processes typically include stripping with chemical solutions containing at least one acid. Chemical stripping of a bondcoat includes first exposing the bondcoat to the acid solution for a certain period of time during which the bondcoat degrades and a weakly adhering decomposition layer or “smut” forms. This layer is then mechanically removed by grit blasting or other forms of abrasion and the process is repeated until the bondcoat is removed. The process is time consuming and labor intensive. What is needed are systems and methods wherein the chemical stripping process of a bondcoat can be accelerated for economical benefit.

The present invention relates to the chemical stripping of certain alloy coatings from superalloy substrates. In particular, the invention relates to carrying out the stripping process in a microwave environment.

According to the invention, nickel and nickel platinum aluminide coatings are removed from superalloy substrates in a microwave environment using a stripping solution consisting of an aqueous solution containing at least one of nitric acid, hydrochloric acid or sulphuric acid and other chemicals.

Microwaves reside in the electromagnetic spectrum between infrared waves and radio waves. Their frequencies range from about 0.3 to 30 GHz, which correspond to wavelengths of about 10 cm to 1 m respectively. The most common frequencies for household and commercial use are 950 MHz (0.915 GHz) and 2.45 GHz. Most household microwave ovens use 2.45 GHz radiation.

In industrial and commercial processing, microwaves are predominantly used for heating. The basic mechanism of microwave heating involves the motion of polar molecules or ions that oscillate under the affect of an oscillating electric or magnetic field. When coupled to the field, the particles try to align themselves to be in phase with the field. Their motion, however, is restricted by interparticle forces and electrical resistance. This resistance generates heat.

Materials respond to microwaves in different ways. Based on this response, materials can be broadly classified as (1) materials that are transparent to microwaves such as some glasses and pottery, (2) materials that reflect microwaves such as most metals, and (3) materials that absorb microwaves such as water and other polar solvents.

Materials that absorb microwaves can be grouped according to three mechanisms of heating: dipolar polarization, electrical conduction, and interfacial polarization.

### Dipolar Polarization

Dipolar polarization is a process during which heat is generated in polar molecules exposed to an oscillating electromagnetic field with a suitable frequency to allow coupling or interaction with the field. The molecules try to align with the field and are restricted by intermolecular or atomic forces. The restriction randomizes the interaction and generates heat. It is important that the frequency range be such that interparticle interactions occur. Inter-particle forces will prevent motion if the frequency is too high, and heating does not occur. On the other hand, if the frequency is too low, particle motion is allowed without restriction and heating also does not occur. Microwave radiation has the frequency range (0.3-30 GHz) that oscillates polar structures and molecules and heats polar solutions and polarized solids. From the standpoint of microwave chemistry, the energy of a microwave photon (0.037 Kcal/mol) is too low to break a molecular bond (80 to 120 Kcal/mol). As a result, microwaves do not alter the chemistry of organic substances. The interaction is simply kinetic. On the other hand, they may alter the energy levels of molecules and atoms as discussed later as the “Microwave Effect”.

### Conduction Mechanism

This mechanism generates heat by resistance to an electric current. The oscillating electromagnetic field generates an oscillation of electrons or ions in a conducting medium resulting in an electric current. The current experiences electrical resistance and Joule heating results.

### Interfacial Polarization

The interfacial polarization mechanism is a combination of the conduction and dipolar polarization mechanisms and is particularly effective in heating systems with high surface to volume ratios such as powders. When powders are irradiated, the incident microwaves are absorbed in induced surface electrical currents that cause resistive heating. In addition, the particles tend to align with the field due to polarized surface charges. Restriction of this motion by surrounding particles also causes heating.

The influence of a microwave environment on chemical reactions is significant. Reaction rates can be three orders of magnitude faster when microwave radiation replaces conventional heating sources such as ovens.

Although the predominant effects of microwaves are to cause heating, it has been suggested that other fundamental mechanisms are at work to increase chemical reaction rates. One theory for this “Microwave Effect” is that microwave radiation acts on particles at the atomic level by exciting them to higher energy levels thereby influencing the free energy and resulting kinetics of chemical reactions. At this time detailed explanations of the “Microwave Effect”, remain controversial.

The invention is particularly useful in the removal of aluminide coatings on superalloy components. Prior art has demonstrated the effectiveness of aqueous solutions of mixtures of nitric, sulfuric, and/or hydrochloric acids and other chemical additives in the removal of aluminide coatings. In the example demonstrated here, a nickel aluminide coated turbine blade was stripped in an aqueous solution of nitric acid. The normal stripping process includes immersion in about 15% to about 20% by weight nitric acid in water. The normal process is to immerse the part for periods of about 1 hour at room temperature, rinse the part, grit blast the part to clean the smut from the surface to reactivate the surface and repeat the process. Typical times to completely remove the aluminide coatings are about 4 hours.

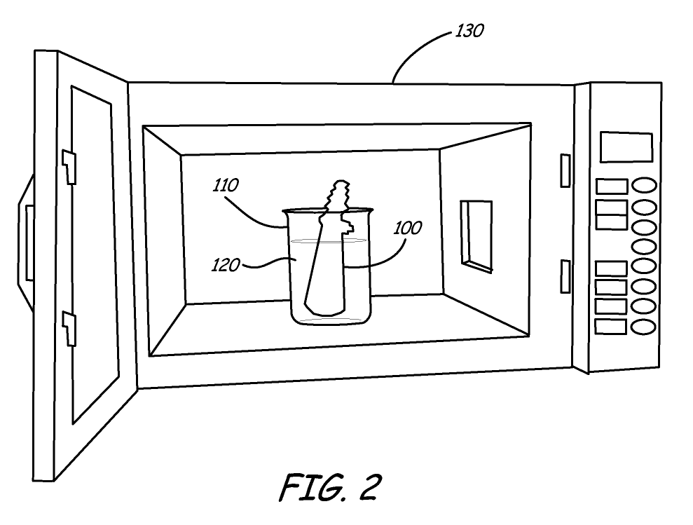

According to the inventive example, the process was repeated in a microwave oven. The oven was a common 2.45 GHz commercial product. FIG. 2 shows turbine blade 100 immersed in beaker 110 containing aqueous nitric acid solution 120 in microwave oven 130. In the example, the acid concentration was about 5% to 10% by weight of nitric acid in water. Times of 4 minutes and 20 minutes were used. Visual inspection following heat tinting indicates the existence of any residual coating. In the case of both 4 minute and 20 minute microwave exposures, the coatings were completely removed by the stripping solution in a single process.

Thus, by carrying out the stripping operation in a microwave environment, the times are significantly shortened, and acid concentrations diluted to get the same results as in a microwave free environment. While 2.45 GHz radiation was used in the example, the use of microwave radiation at other frequencies is within the scope of the invention. In addition, while the example demonstrations were carried out at ambient temperatures, both elevated and depressed temperatures could be used.

Although the present invention has been described with reference to preferred embodiments, workers skilled in the art will recognize that changes may be made in form and detail without departing from the spirit and scope of the invention.

1. A chemical stripping method of removing a metallic coating from a substrate comprising:
contacting the coating with a chemical solution containing at least one acid known to dissolve the coating; and
applying microwave radiation to the chemical solution.

2. The method of claim 1, wherein a reaction rate of the removal is accelerated by the microwave radiation as compared to when microwave radiation is not used.

3. The method of claim 1, wherein the microwave radiation results in the use of diluted chemical solutions as compared to when microwave radiation is not used.

4. The method of claim 1, wherein the stripping method is carried out without repeating steps.

5. The method of claim 1, wherein the stripping method is carried out at ambient temperature.

6. The method of claim 1, wherein the stripping method is carried out at an elevated temperature.

7. The method of claim 1, wherein the metallic coating is a diffusion aluminide material.

8. The method of claim 1, wherein the substrate comprises one of a nickel, cobalt, or iron based superalloy.

9. The method of claim 8, wherein the superalloy comprises a high temperature gas turbine component.

10. A method for repairing an engine run turbine component, the method comprising:
removing a diffusion aluminide bondcoat using microwave assisted chemical stripping in a chemical solution;
repairing the component; and
reapplying the diffusion aluminide coating.

11. The method of claim 10, wherein a reaction rate of the chemical stripping is accelerated by microwave radiation as compared to when microwave radiation is not used.

12. The method of claim 10, wherein the turbine component comprises one of a nickel, cobalt or iron based superalloy.

13. The method of claim 10, wherein the turbine component comprises a turbine blade or vane.

14. The method of claim 10, wherein the chemical solution contains at least one acid.

15. The method of claim 10, wherein the removing is carried out in a single step.

16. A system for chemically stripping a metallic coating from a substrate comprising:
a container;
a chemical solution disposed in the container and containing at least one acid capable of dissolving the metallic coating on the substrate; and
a microwave radiation source.

17. The system of claim 16 wherein a reaction rate of the dissolution of the metallic coating is accelerated by the microwave radiation source as compared to when the microwave radiation source is not used.

18. The system of claim 16 wherein the microwave radiation source results in the use of diluted chemical solutions as compared to when the microwave radiation source is not used.

19. The system of claim 16 wherein the metallic coating is a diffusion aluminide material.

20. The system of claim 16 wherein the substrate comprises one of a nickel, cobalt, or iron based superalloy.
